(19) United States
(12) Patent Application Publication
(10) Pub. No.: US 2026/0170941 A1
(43) Pub. Date: Jun. 18, 2026

(54) INFORMATION MANAGEMENT APPARATUS, SYSTEM, METHOD, AND NON-TRANSITORY COMPUTER-READABLE STORAGE MEDIUM

(71) Applicant: HONDA MOTOR CO., LTD., Tokyo (JP)

(72) Inventors: Takashi Oshima, Wako-shi (JP); Naotoshi Fujimoto, Wako-shi (JP); Ryo Iitaka, Wako-shi (JP); Tsuyoshi Nojiri, Wako-shi (JP); Moriya Horiuchi, Wako-shi (JP)

(73) Assignee: HONDA MOTOR CO., LTD., Tokyo (JP)

(21) Appl. No.: 19/400,322

(22) Filed: Nov. 25, 2025

(30) Foreign Application Priority Data
Dec. 13, 2024 (JP) 2024-218967

(51) Int. Cl. G08B 25/10; G08B 21/04

(52) U.S. Cl. CPC G08B 25/10; G08B 21/0461

(57) ABSTRACT

An information management apparatus configured to manage information about a user, comprises an identification unit configured to identify a position of the user in a plurality of persons, in a case where the plurality of persons including the user are located in a predetermined area, and a notification unit configured to give a notification for encouraging the user to support another person in the plurality of persons, in a case where the user is identified to be in a senior position in the plurality of persons by the identification unit.

### CROSS-REFERENCE TO RELATED APPLICATION(S)

This application claims priority to and the benefit of Japanese Patent Application No. 2024-218967, filed Dec. 13, 2024, the entire disclosure of which is incorporated herein by reference.

### BACKGROUND OF THE INVENTION

### Field of the Invention

The present invention mainly relates to an information management apparatus.

### Description of the Related Art

In recent years, efforts have been made to provide a sustainable transportation system that gives consideration to people in vulnerable situations among traffic participants. With regard to preventive safety technology to achieve such a transportation system, research and development for further improving traffic safety and convenience are focused on (see Japanese Patent No. 7523347).

It is needless to say that there is a need for generally applicable technology as preventive safety technology, but the technology corresponding to every region can be also demanded.

### SUMMARY OF THE INVENTION

In order to address the above issue, it is an object of the present application to provide a technology that is advantageous for enhancing regional safety, which contributes to development of a sustainable transportation system, accordingly.

One of the aspects of the present invention provides an information management apparatus configured to manage information about a user, the information management apparatus comprising an identification unit configured to identify a position of the user in a plurality of persons, in a case where the plurality of persons including the user are located in a predetermined area, and a notification unit configured to give a notification for encouraging the user to support another person in the plurality of persons, in a case where the user is identified to be in a senior position in the plurality of persons by the identification unit.

Further features of the present invention will become apparent from the following description of exemplary embodiments with reference to the attached drawings.

### BRIEF DESCRIPTION OF THE DRAWINGS

FIG. 1 is a diagram illustrating an example of a configuration of a system according to an embodiment;

FIG. 2 is a flowchart illustrating an example of processing contents of a mobile terminal;

FIG. 3 is a flowchart illustrating an example of processing contents of the mobile terminal;

FIG. 4 is a flowchart illustrating an example of processing contents of a server;

FIG. 5 is a flowchart illustrating an example of processing contents of the server; and

FIG. 6 is a diagram illustrating an example of a configuration of the system.

### DESCRIPTION OF THE EMBODIMENTS

Hereinafter, embodiments will be described in detail with reference to the attached drawings. Note that the following embodiments are not intended to limit the scope of the claimed invention, and limitation is not made an invention that requires all combinations of features described in the embodiments. Two or more of the multiple features described in the embodiments may be combined as appropriate. Furthermore, the same reference numerals are given to the same or similar configurations, and redundant description thereof is omitted.

### First Embodiment

### System Configuration

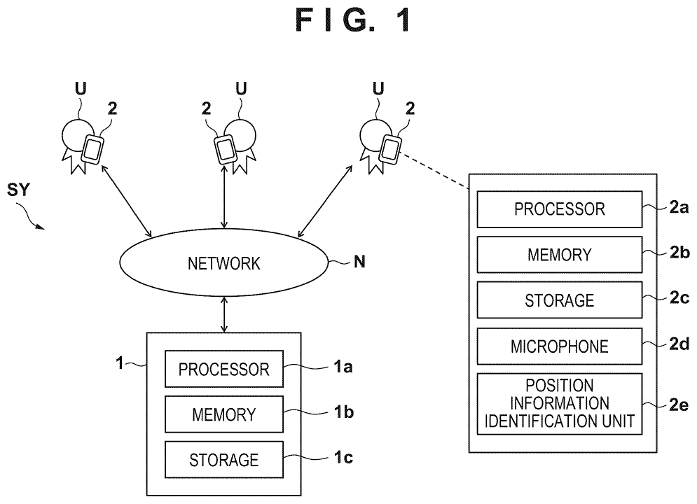

FIG. 1 is a diagram illustrating an example of a configuration of a system SY according to an embodiment. The system SY includes a server 1 and one or more (here, three) mobile terminals 2. The server 1 and the individual mobile terminals 2 are capable of communicating with each other through a network N.

The server 1 includes a processor 1a, a memory 1b, and a storage 1c. The processor 1a is an operation unit that performs arithmetic processing for enabling each function in the server 1 in a broad sense, and includes, for example, a central processing unit (CPU), a micro processing unit (MPU), a graphics processing unit (GPU), and the like. The memory 1b is a storage medium that temporarily stores intermediate data and the like for use in the arithmetic processing of the processor 1a, and a volatile storage medium such as a random access memory (RAM) or a read only memory (ROM) can be typically used. The storage 1c is a storage medium that stores information necessary for the arithmetic processing of the processor 1a, such as programs and parameters, data indicating a result of the arithmetic processing, and the like, and a non-volatile storage medium such as a hard disk drive (HDD) or a solid state drive (SSD) can be typically used.

The server 1 may further include: an operation input unit such as a hardware key, a software key, or a lever; and a display unit such as a liquid crystal display or an organic EL display, so an administrator of the server 1 is able to input or update necessary information using the operation input unit and the display unit. The administrator of the server 1 corresponds to a provider of a service to be described later, and the service is provided for the individual mobile terminals 2 through the network N.

It is assumed that one or more mobile terminals 2 are respectively associated with one or more users U. The association described here is sufficient if the user U is registered as the owner of the mobile terminal 2 or the user U actually owns the mobile terminal 2. Each of the mobile terminals 2 includes a processor 2a, a memory 2b, and a storage 2c. The processor 2a, the memory 2b, and the storage 2c may be configured to be respectively capable of enabling functions similar to those of the processor 1a, the memory 1b, and the storage 1c. As the mobile terminal 2, a known portable terminal such as a smartphone, a tablet terminal, or a wearable device can be typically used.

Each of the mobile terminals 2 further includes a microphone 2d and a position information identification unit 2e. The microphone 2d is capable of acquiring sound information in the surroundings of the user U, in addition to utterances of the user U, by using its sound collection function. The position information identification unit 2e is configured to be capable of identifying position information of the self-device (the mobile terminal 2), and its function is enabled using, for example, a global navigation satellite system (GNSS).

The outline of the service according to the present embodiment is to promote enhancement of safety consciousness of the user U using the mobile terminal 2, and to achieve enhancement of regional safety (hereinafter, referred to as the present service). A program distributed from the server 1 as a part of the present service is installable in the mobile terminal 2 (hereinafter, referred to as the present program). Prior to receiving the present service, the user U is able to download and install the present program in the mobile terminal 2 through the network N, in many cases.

The present service is mainly available when the user U goes out with the mobile terminal 2. The user U is a school student (younger than 18 years old) who attends school in many cases, but may be an adult (18 years old or older).

### Regarding User Registration of The Present Service

In the present embodiment, in using the present service, it is assumed that the user U performs user registration beforehand.

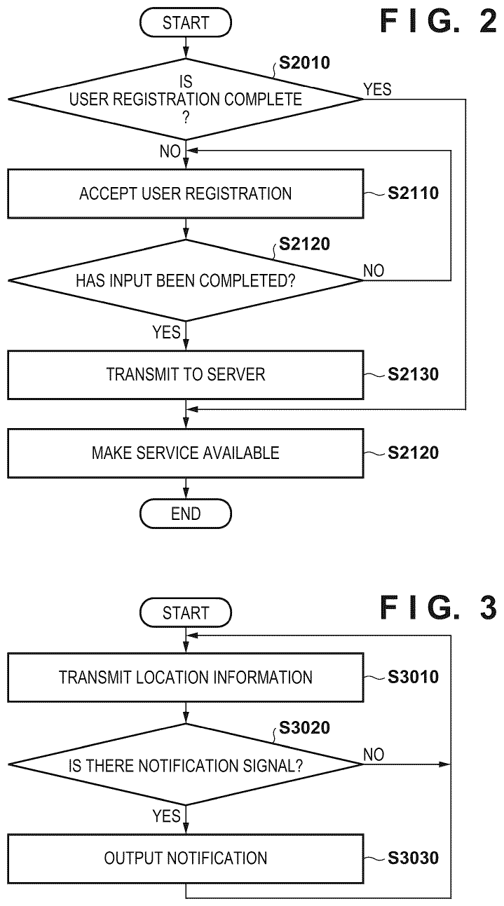

FIG. 2 is a flowchart illustrating an example of processing contents of the mobile terminal 2 at the time of user registration. Steps in the present flowchart may be mainly performed by the processor 2a. The present flowchart can be started, for example, based on activation of the present program in accordance with an operation input into the mobile terminal 2, or based on power-on of the mobile terminal 2 in which the present program is installed.

In step S2010 (hereinafter, referred to as “S2010”. The same applies to the other steps to be described later), the presence or absence of user registration is determined. In a case where the user is already registered, processing proceeds to S2020, and in the other case (in a case where the user is unregistered), the processing proceeds to S2110.

In S2020, although details will be described later, the present service is started, and the present flowchart ends.

In S2110, the user registration is accepted, and during that time, the user U is able to input necessary information (hereinafter, referred to as user information) on the mobile terminal 2. The user information includes personal information such as a name, a date of birth, and an e-mail address of the user U, in many cases. However, according to the present embodiment, the user information may only include information necessary for identifying the age of the user U or an element related to the age (for example, school grade).

In S2120, it is determined whether the input of the user information has been completed. In a case where the input of the user information is completed, the processing proceeds to S2130, and in the other case, the processing returns to S2110.

In S2130, the user information that has been input is transmitted to the server 1 through the network N, and then the processing proceeds to S2020. The user information that has been transmitted is stored in the storage 1c, and then the user registration is completed.

### Regarding Processing Contents in The Present Service

### Processing Contents on Mobile Terminal

FIG. 3 is a flowchart illustrating an example of processing contents of the mobile terminal 2 in using the present service. The present flowchart can be started, for example, based on activation of the present program in the mobile terminal 2 of the user U who has been registered as a user, or based on power-on of the mobile terminal 2.

In S3010, the position information of the mobile terminal 2 is transmitted to the server 1, as the position information of the user U. This is achievable by the position information identification unit 2e (see FIG. 1).

In S3020, presence or absence of a notification signal to be described later is determined. The notification signal is receivable from the server 1. In a case where the notification signal is received from the server 1, the processing proceeds to S3030, and in the other case, the processing returns to S3010.

In S3030, a notification to be described later is output in accordance with the notification signal from the server 1, and the processing returns to S3010. The notification output may draw some kind of attention of the user U, an alarm function of the mobile terminal 2 may be used, or a vibration function of the mobile terminal 2 may be used. Incidentally, mechanical voice or the like of contents of the notification may be output, or character information indicating the contents of the notification may be displayed on the display of the mobile terminal 2.

### Processing Contents on Server

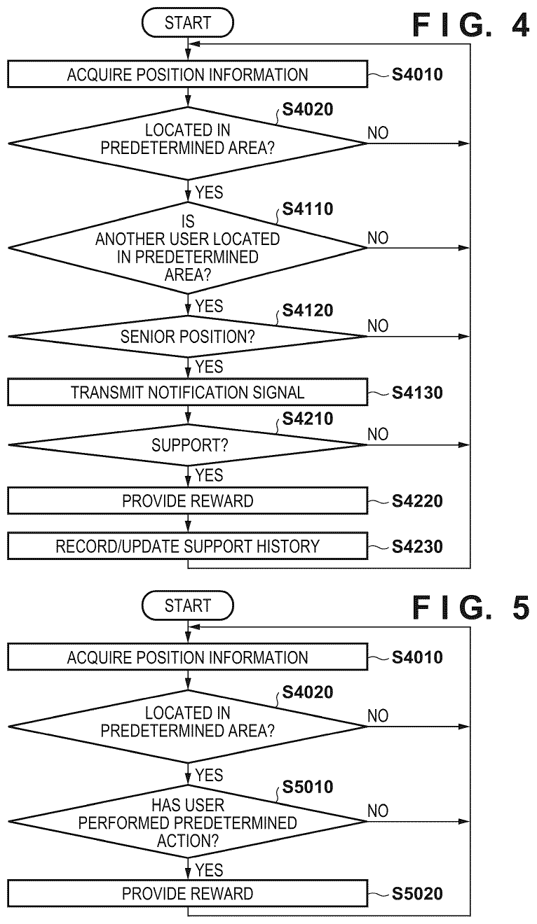

FIG. 4 is a flowchart illustrating an example of processing contents of the server 1 in providing the present service. The outline of the present flowchart is that in a case where a plurality of users U are located in a predetermined area, a user U in a senior position among the users U is identified to encourage the user U to support any other user U. The following steps can be mainly performed by the processor 1a. The present flowchart may be started, for example, in response to distribution start of the present program or provision start of the present service.

In S4010, the position information of each user U, who is already registered as a user, is acquired. Here, the position information of the user U is identifiable, based on the position information transmitted from the mobile terminal 2 (see S3010).

In S4020, it is determined whether a given user U is located in a predetermined area. This determination is enabled by associating the position information of the user U obtained in S4010 with existing map data. It is assumed that the predetermined area is set beforehand in the map data, and according to the present embodiment, the predetermined area is set as a warning area where attention is needed in passing through. The warning area may be an area to which notice for attention has been given by a local government or an administrative government, or may be an area set on the server 1, based on information provided from a user U (or a concerned person). Its typical examples include a crosswalk. The warning area may be expressed as a caution-needed area, or may be expressed as an attention-needed area in a broader sense.

In a case where any of the users U (a user U1 in order to distinguish from the other users to be described later) is located in a warning area, the processing proceeds to S4110, and in the other case, the processing returns to S4010.

In S4110, it is determined whether another user U (another user U2 for distinction) is located in such a warning area. Here, the position information of another user U2 is identifiable, based on the position information transmitted from the mobile terminal 2 of another user U2 in a similar manner to the position information of the user U1 (see S4010).

In a case where another user U2 is located in the warning area, the processing proceeds to S4120, and in the other case, the processing returns to S4010.

In S4120, it is determined whether the user U1 is in a senior position in relation to another user U2. This determination may be made, based on the user information stored in the storage 1c (see FIG. 2). As an example, in a case where the user U1 is older than another user U2, the user U1 is identified to be in the senior position. As another example, in a case where the user U1 is higher in school grade than another user U2, the user U1 is identified to be in the senior position.

In a case where the user U1 is identified to be in the senior position, the processing proceeds to S4130, and in the other case, the processing returns to S4010.

In S4130, a notification signal is transmitted to the mobile terminal 2 of the user U1. This notification signal corresponds to the notification signal in S3020 (see FIG. 3).

That is, in a case where a plurality of users U are located in a warning area, the server 1 identifies a user U who is in a senior position among the users U, and transmits a notification signal to the mobile terminal 2 of the user U (the user U1 in the above-described example) who is identified to be in the senior position. The mobile terminal 2 that has received the notification signal outputs a notification for encouraging support, for example, using an alarm function (see S3030). This enables the user U who is identified to be in the senior position to appropriately support another user U (the user U2 in the above-described example).

The support mentioned here may be any supporting action for another user U (the user U2 in the above-described example) to appropriately complete passing through the warning area, and may be expressed as assistance, guide, or escort.

In S4210, it is determined whether the user U1 has supported the user U2. In a case where it is determined that the user U1 has supported the user U2, the processing proceeds to S4220, and in the other case, the processing returns to S4010.

Here, as an example, the determination in S4210 is enabled, based on the position information of each of the users U1 and U2. For example, the position information of the users U1 and U2 is acquired in a procedure similar to S4010, so the determination can be made, based on relative movement modes of their positions. Specifically, while the positions of the users U1 and U2 are moving in the warning area, when the position of the user U1 intermittently moves along the trajectory of the position of the user U2, it can be determined that support by the user U1 has been given.

As another example, the determination in S4210 may be enabled, based on voice information obtained by the microphone 2d (see FIG. 1), and may be enabled, for example, by conducting a known voice analysis on the voice of the user U1. Here, it is assumed that the voice information acquired by the mobile terminal 2 is transmitted to the server 1, and voice analysis is conducted by the processor 1a. Specifically, in a case where voice such as “You can pass” or “A car is coming” of the user U1 are confirmed, it can be determined that support has been given from the user U1. Note that the voice of the user U may be registered beforehand at the time of user registration, for example.

The determination of S4210 is enabled with high accuracy with reference to both the above-described position information and voice information. For example, it is possible to determine whether the mode of support by the user U1 conforms to the contents of the notification output in S3030, based on both the position information and the voice information. As an example, in a case where the contents of the notification output in S3030 are those for encouraging the user to talk to another user in the surroundings, the determination in S4210 is appropriately enabled, based on the voice information.

In S4220, a reward is provided for the user U1 in response to the determination that the user U1 has supported the user U2. The provision of the reward mentioned here means associating information of the reward with the user U1, specifically, allowing the user U1 to use the information of the reward by using the mobile terminal 2 (to use mentioned here can be interpreted in a broad sense including presentation of the reward to a third party and private viewing). Typical examples of the reward may include point(s) available at a given store, but any incentive may be used, and the presence or absence of a monetary value is irrelevant.

Alternatively, the reward may be provided for the user U1, based on a request from the user U2 who has been supported. This request may be enabled, for example, by the user U2 making a predetermined operation input on his/her own mobile terminal 2. In this case, in a case where it is determined that the user U1 has supported the user U2, a notification for confirmation may be output to the mobile terminal 2 of the user U2. This enables the server 1 to appropriately provide the reward for the user U1.

In S4230, a support history of the user U1 is recorded or updated. It is only necessary for the support history to indicate records of support. The support history typically includes a cumulative number of times of giving the support. However, in a case where a warning level is set for a warning area, the support history may be obtained by weight-adding the cumulative number of times, based on such a warning level. Note that it is sufficient to set the support history of each user U to “no record” as an initial state at the time of user registration, for example.

This support history may be additionally referred to in the determination of S4120 (the determination of whether the user U is in the senior position). In the above-described example, a mode of making the determination in S4120, based on the age of the user U, has been described. However, for example, even though the user U1 is older than another user U2, it is conceivable that the user U1 has no support record. For this reason, the support history may be referred to in the determination in S4120. That is, the determination in S4120 is desirably made, based on the age and/or the support history of the user U.

### Brief Summary

According to the present embodiment, the user U actively supports in a warning area. This promotes enhancement of safety consciousness, and is advantageous in preventing an accident. In addition, it becomes possible to enhance regional safety, which contributes to regional activation and development of a sustainable transportation system, accordingly.

According to the present embodiment, the warning area has been described as a typical example of a predetermined area where the present service is mainly utilized, and a crosswalk has been given as its example. There may or may not be a traffic light at a crosswalk, but according to the present embodiment, it is particularly advantageous in a case of a crosswalk where no traffic light is installed.

According to the present embodiment, the mobile terminal 2 functions as an information management apparatus that manages information of the user U. At least a part of the processing contents performed by the processor 2a of the mobile terminal 2 may be performed by the processor 1a of the server 1, that is, the function of the information management apparatus is enabled by the server 1 and/or the mobile terminal 2. The same reasoning also applies to the other embodiments to be described below.

### Second Embodiment

In the above-described first embodiment, in order to facilitate the description, the description has been made with regard to the case where the user U1 in a senior position and the user U2 in a junior position are located in a warning area. In this case, the user U2 in a junior position has no opportunity to receive a reward, and it can be said that they would have no motivation to install the present program to use the present service. Hence, the present service is desirably provided to create motivation for using the present service also in a case where the user is not in the senior position.

FIG. 5 is a flowchart illustrating an example of processing contents of the server 1. In a similar manner to the flowchart of FIG. 4, which has been described in the first embodiment, the present flowchart is started, for example, in response to distribution start of the present program or provision start of the present service. The outline is to determine the presence or absence of a predetermined action taken by the user U when the user U passes through a warning area, and to provide a reward for the user U in a case where the predetermined action has been taken.

In a case where it is determined in S4020 that the user U is located in a warning area, it is determined in S5010 whether the user U has taken a predetermined action. The predetermined action mentioned here may be confirmation in the warning area or a behavior equivalent to it. Typical examples include an action of the user U checking left and right (hereinafter, referred to as a confirmation action).

Here, the determination in S5010 is enabled, based on the position information of the user U in a similar manner to the determination in S4210. For example, before the position of the user U begins to move in the warning area, in a case where the position of the user U stops for a predetermined period of time (for example, several seconds), it is possible to determine that the confirmation action has been taken by the user U. In a case where the mobile terminal 2 is a wearable device (for example, a device to be wearable on the arm, the head, or the like), the determination in S5010 can be realized with high accuracy.

In a case where it is determined that the confirmation action has been taken by the user U, the processing proceeds to S5020, and in the other case, the processing returns to S4010.

In S5020, a reward is provided for the user U in response to the determination that the confirmation action has been taken by the user U.

Note that the steps of S5010 to S5020 in the present flowchart may be performed in parallel with the step S4110 and later steps in FIG. 4.

According to the present embodiment, there is an opportunity to provide a reward also in a case where the user U is not in a senior position (in the case of the user U2 in the example according to the first embodiment), and there is also an opportunity to provide a reward for the user U who moves alone in the warning area. Therefore, according to the present embodiment, it becomes possible to utilize the present service widely (it is usable for a wider range of users), and to further enhance regional safety, accordingly.

### Third Embodiment

In the above-described first and second embodiments, in order to facilitate the description, the description has been made with regard to the case where two users U in total including the users U1 and U2 are located in a warning area. However, it is also conceivable that three or more users U are located in the warning area. For example, in a case where further another user U (another user U3 for distinction) is located in such a warning area, in addition to the users U1 and U2, and the user U1 is the oldest and the user U2 is the youngest, the user U3 can be in a middle position.

In such a case, the notification for encouraging support does not have to be given to the user U3. However, when the user U3 actively supports, it can be said that such an action comes from a high level of safety consciousness of the user U3. Therefore, in such a case, a reward may be provided for the user U3. Note that it is possible to determine the presence or absence of support of the user U3, based on the position information (and the voice information), in a similar manner to the determination in S4210.

### Fourth Embodiment

According to the above-described first embodiment, it is presupposed that a person to be supported (the user U2 in the example of the first embodiment) has been registered as a user. However, the user registration of the person to be supported is not essential. For example, the contents in the first embodiment can be realized by a monitoring camera, which is in connection with the network N, and which is installed in a warning area or its surroundings.

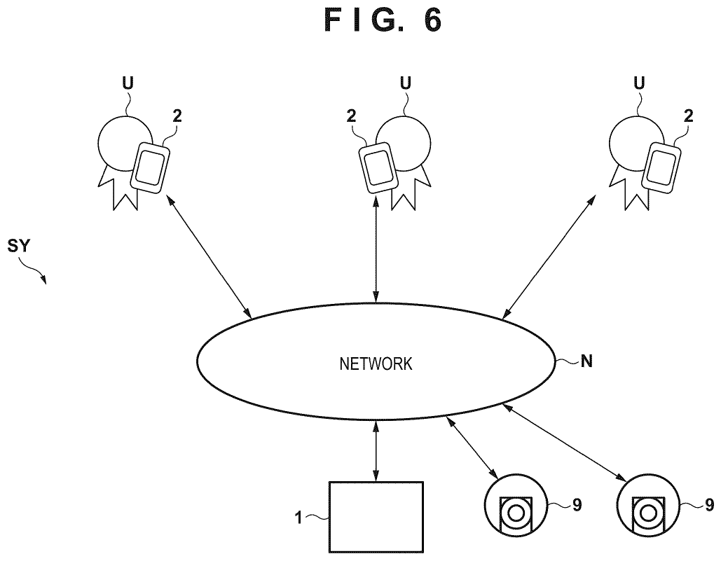

FIG. 6 is a diagram illustrating an example of a configuration of a system SY according to the fourth embodiment. In the present embodiment, the system SY further includes one or more (here, two) monitoring cameras 9. It is sufficient for each monitoring camera 9 to be capable of communicating with the server 1 and/or the mobile terminal 2 through the network N. Each monitoring camera 9 may be configured integrally with a communication device or separately from the communication device. The monitoring camera 9 is installed so as to correspond to any of the warning areas and so that an area to be monitored includes a warning area, or so as to be capable of monitoring a warning area, and a monitoring result of the monitoring camera 9 is transmitted to the server 1.

According to the present embodiment, in the flowchart of FIG. 4, the server 1 is capable of making the determination in S4120 (the determination of whether the user U is in a senior position) and the determination in S4210 (the determination of presence or absence of support), based on the monitoring result of the monitoring camera 9.

According to the present embodiment, in S4120, it is determined whether the user U is in a senior position, based on the monitoring result received from the monitoring camera 9 (a moving image showing a plurality of persons located in the warning area, that is, a plurality of persons including the user U. Instead of the moving image, one or more still images may be used). This determination may be made according to a known image analysis technique. In the image analysis, since there is no user information about the other persons except for the user U in the plurality of persons located in the warning area, the determination in S4120 can be usually made, based on a comparison of heights of the persons. It is sufficient if an image of the user U itself for identifying the user U in such a situation is registered beforehand, for example, at the time of user registration.

In addition, in S4210, it is determined whether the user U identified to be in the senior position has supported another person, based on the monitoring result received from the monitoring camera 9. In the above-described first embodiment, the determination in S4210 has been made, based on the position information (and the voice information) of the user U. However, according to the present embodiment in which it becomes possible to evaluate the behavior of the user U in detail in the image analysis, it can be said that such evaluation can be realized with higher accuracy.

According to the present embodiment, a person to be supported may not necessarily be the user of the present service. The present service can be utilized in a case where a plurality of persons including the user U are located in the warning area. More briefly, in the present service, it is sufficient if the user registration of at least one of a plurality of persons located in the warning area has been performed, and the user registration for all the persons is not essential. In a case where the user U is identified to be in the senior position in such a plurality of persons, a notification is given to the user U to encourage the user U to support another person (see S3030 and S4130).

### Fifth Embodiment

In the above-described first embodiment, it is conceivable that the map data is not updated, and a new warning area is not set on the map data. In such a case, the monitoring result of the monitoring camera 9, as described in the above-described fourth embodiment, may be transmitted to the server 1 and/or the mobile terminal 2. In this case, the monitoring camera 9 is not installed in a warning area, but when a predetermined condition is satisfied, an area to be monitored by the monitoring camera 9 is set as the warning area.

As an example, the monitoring camera 9 includes an evaluation means capable of evaluating a warning level in the area to be monitored, and sets the area to be monitored as a warning area, based on an evaluation result. For example, in a case where a traffic volume of vehicles and/or persons in a certain area meets a reference threshold (in a case where the traffic volume of the vehicles exceeds a first reference amount, in a case where the traffic volume of the persons is less than a second reference amount, or the like), the area may be set as a warning area.

Information of the warning area set in this manner is transmitted to the server 1, so that the map data can be updated by the processor 1a. According to such a configuration, it becomes possible to reduce the processing load on the server 1, and it also becomes possible to avoid a significant change in an existing infrastructure.

### Modifications

A part or all of the above contents can be combined with each other. In such a case, other configurations may be further combined within a range not departing from the gist of the contents, so that regional safety can be further enhanced.

For example, according to the combination of the second to fourth embodiments, since a person to be supported does not have to be a user of the present service, the user U may be motivated to actively support such a person regardless of whether the person to be supported is the user of the present service. This enables the present service to be widely used, so that regional safety can be further enhanced, accordingly.

### Others

In the above embodiments, an aspect of achieving the present service mainly by a processor executing a program has been described. However, the present invention is not limited to this. For example, a dedicated portable terminal may be used instead of the mobile terminal 2 in which the present program is installed. The dedicated portable terminal may be configured to include a processor capable of executing the present program, or may include an application specific integrated circuit (ASIC) capable of enabling equivalent functions. That is, the processing contents that have been given as examples in the embodiments described heretofore are enabled by both hardware and software.

In addition, the contents that have been given as examples in the embodiments described heretofore can be changed without departing from its gist. For example, the order of steps that have been illustrated in some flowcharts may be partially changed.

In the description given heretofore, in order to facilitate the understanding, each element is indicated with a name related to its functional aspect. However, each element is not limited to an element including the content described in the embodiments as a main function, and may be an element including the content as a supplementary function. Therefore, each element is not strictly limited to the expression, and the expression is replaceable with another similar expression.

In addition, two or more elements that have been selectively given as examples in the embodiments are not strictly limited to its illustration, and may be optionally combined together. For example, two or more elements listed by “and/or” may be additionally or alternatively selected. As an example, for two elements of A and B, the expression “A and/or B” indicates only A, only B, and both A and B, and may be rephrased as “at least one of A and B”.

### Summary of Embodiments

Some characteristics that have been given as examples in the embodiments described heretofore are as follows.

### [Item 1]

An information management apparatus (1, 2) configured to manage information about a user (U), the information management apparatus comprising:
an identification unit (S4120) configured to identify a position of the user in a plurality of persons, in a case where the plurality of persons including the user are located in a predetermined area; and
a notification unit (S4130) configured to give a notification for encouraging the user to support another person (U2) in the plurality of persons, in a case where the user is identified to be in a senior position in the plurality of persons by the identification unit.

Thus, it becomes possible to promote enhancement of the safety consciousness of the users and to achieve enhancement of regional safety, accordingly.

### [Item 2]

The information management apparatus according to Item 1, further comprising a provision unit (S4220) configured to provide a reward for the user, in a case where the user supports the another person.

Thus, it becomes possible to further promote enhancement of the safety consciousness of the user.

### [Item 3]

The information management apparatus according to Item 1 or 2, further comprising a provision unit (S4220) configured to provide a reward for the user, based on a request from the another person.

Thus, a reward can be appropriately provided for the user.

### [Item 4]

The information management apparatus according to any one of Items 1 to 3, further comprising a registration unit (S2130) configured to register information indicating an age of the user, wherein
the identification unit identifies the position of the user, based on the age of the user.

This makes it possible to appropriately identify whether the user is in a senior position.

### [Item 5]

The information management apparatus according to any one of Items 1 to 4, further comprising a storage unit (S4230) configured to store a support history of the user, wherein
the identification unit identifies the position of the user, based on the support history.

This makes it possible to appropriately identify whether the user is in a senior position.

### [Item 6]

An information management apparatus (1, 2) configured to manage information about a user (U), the information management apparatus comprising:
an identification unit (S4120) configured to identify a position of the user in a plurality of persons, in a case where the plurality of persons including the user are located in a predetermined area; and
a provision unit (S4220) configured to provide a reward for the user when the user supports another person (U2) in the plurality of persons, in a case where the user is identified to be in a senior position in the plurality of persons by the identification unit.

Thus, it becomes possible to promote enhancement of the safety consciousness of the users and to achieve enhancement of regional safety, accordingly.

### [Item 7]

The information management apparatus according to any one of Items 1 to 6, wherein the information management apparatus is a mobile terminal (2).

That is, the above-described information management apparatus is applicable to a known mobile terminal such as a smartphone.

### [Item 8]

A system (SY) comprising:
a server (1) serving as the information management apparatus of any one of Items 1 to 6; and
at least one mobile terminal (2) associated with at least one user, and configured to be capable of communicating with the server.

That is, the above-described information management apparatus is applicable as a server to a system through a network.

### [Item 9]

A non-transitory computer-readable storage medium storing a program for causing a computer to function as each unit of the information management apparatus of any one of Items 1 to 6.

That is, the functions of the above-described information management apparatus are enabled by a program.

### [Item 10]

A method for managing information about a user, the method comprising:
a step (S4120) of identifying a position of the user in a plurality of persons, in a case where the plurality of persons including the user are located in a predetermined area; and
a step (S4220) of giving a notification for encouraging the user to support another person (U2) in the plurality of persons, in a case where the user is identified to be in a senior position in the plurality of persons.

This enables the effects similar to those of Item 1.

The invention is not limited to the foregoing embodiments, and various variations/changes are possible within the spirit of the invention.

What is claimed is:

1. An information management apparatus configured to manage information about a user, the information management apparatus comprising:
an identification unit configured to identify a position of the user in a plurality of persons, in a case where the plurality of persons including the user are located in a predetermined area; and
a notification unit configured to give a notification for encouraging the user to support another person in the plurality of persons, in a case where the user is identified to be in a senior position in the plurality of persons by the identification unit.

2. The information management apparatus according to claim 1, further comprising a provision unit configured to provide a reward for the user, in a case where the user supports the another person.

3. The information management apparatus according to claim 1, further comprising a provision unit configured to provide a reward for the user, based on a request from the another person.

4. The information management apparatus according to claim 1, further comprising a registration unit configured to register information indicating an age of the user, wherein
the identification unit identifies the position of the user, based on the age of the user.

5. The information management apparatus according to claim 1, further comprising a storage unit configured to store a support history of the user, wherein
the identification unit identifies the position of the user, based on the support history.

6. An information management apparatus configured to manage information about a user, the information management apparatus comprising:
an identification unit configured to identify a position of the user in a plurality of persons, in a case where the plurality of persons including the user are located in a predetermined area; and
a provision unit configured to provide a reward for the user when the user supports another person in the plurality of persons, in a case where the user is identified to be in a senior position in the plurality of persons by the identification unit.

7. The information management apparatus according to claim 1, wherein the information management apparatus is a mobile terminal.

8. A system comprising:
a server serving as the information management apparatus of claim 1; and
at least one mobile terminal associated with at least one user, and configured to be capable of communicating with the server.

9. A non-transitory computer-readable storage medium storing a program for causing a computer to function as each unit of the information management apparatus of claim 1.

10. A method for managing information about a user, the method comprising:
a step of identifying a position of the user in a plurality of persons, in a case where the plurality of persons including the user are located in a predetermined area; and
a step of giving a notification for encouraging the user to support another person in the plurality of persons, in a case where the user is identified to be in a senior position in the plurality of persons.
